(19) United States
(12) Patent Application Publication
(10) Pub. No.: US 2022/0235438 A1
(43) Pub. Date: Jul. 28, 2022

(54) ASSEMBLY COMPRISING A ROTARY WHEEL MADE OF A NON-MAGNETIC MATERIAL AND A BEARING PROVIDED WITH A CONE

(71) Applicant: ETA SA Manufacture Horlogère Suisse, Grenchen (CH)

(72) Inventors: Cyril RUCHTI, Yverdon-les-Bains (CH); Xavier BERDAT, Vicques (CH); Frédéric KOHLER, Avry-sur-Matran (CH)

(73) Assignee: ETA SA Manufacture Horlogère Suisse, Grenchen (CH)

(21) Appl. No.: 17/646,317

(22) Filed: Dec. 29, 2021

(30) Foreign Application Priority Data
Jan. 22, 2021 (EP) 21152892.2

(51) Int. Cl. C22C 30/02; G04B 31/008; C22C 21/10; G04B 43/00

(52) U.S. Cl. CPC C22C 30/02; G04B 43/007; C22C 21/10; G04B 31/008

(57) ABSTRACT

An assembly (10), in particular fora timepiece, including a rotary wheel and a bearing, like a jewel (20), the rotary wheel being provided with at least one pivot (17) including at least partly a non-magnetic material, preferably entirely, the bearing including a face (6) provided with a hole (8) formed in the body of the bearing and with a functional geometry at the entrance of the hole (8), wherein the functional geometry has the shape of a cone (12), and wherein the non-magnetic material of the pivot (17) includes an alloy to be chosen from materials containing copper, materials containing palladium or materials containing aluminium.

### CROSS REFERENCE TO RELATED APPLICATION

This application claims priority to European Patent Application No. 21152892.2 filed Jan. 22, 2021, the entire contents of which are incorporated herein by reference.

### FIELD OF THE INVENTION

The invention relates to an assembly comprising a rotary wheel provided with a pivot made of a non-magnetic material and a bearing provided with a cone, in particular for a timepiece.

The invention also relates to a timepiece including such an assembly.

### BACKGROUND OF THE INVENTION

In the prior art in horology, rotary wheels, such as balances, generally include two pivots, the ends of which are inserted into jewels to be able to rotate. Generally, jewels of the ruby or sapphire type are used to form endstones or guide elements called bearings. The bearings can also be metal. These endstones and guide elements are intended to come in contact with the pivots in order to make the latter mobile in rotation, with minimum friction. Thus, they form, for example, all or part of a bearing-block of the arbor of the wheel mounted in rotation.

In principle, synthetic jewels are used in horological movements. In particular, the method of the Verneuil type is known for manufacturing jewels of the monocrystalline type. There are also the stones of the polycrystalline type, which are manufactured by pressing of a precursor with a view to obtaining a green body of the future jewel on the basis of a pressing tool.

The jewels used as an element for guiding a pivot in rotation have, generally, a through-hole into which the pivot is inserted to bear on an endstone. It is known to form a substantially hemispherical recess around the hole on the face of insertion of the pivot to facilitate the insertion of the pivot. Moreover, it allows to put the pivot back in place in the case in which the latter comes out because of an impact. The recess is, for example, obtained by turning with a diamond graver.

FIG. 1 is an example of the prior art, of an assembly 1 comprising a jewel 2 provided with a hole 3 and a hemispherical recess 4 forming the entrance of the hole 3. The assembly 1 further comprises a pivot 7 configured to be inserted into the hole 3 in order to allow the rotation of a mobile element, not shown in the drawing.

Moreover, magnetism is a significant problem for horological movements, since it harms the precision of the movements. To resolve this problem, it is also known to use non-magnetic materials to form certain parts of the movement. Thus, these non-magnetic materials allow to produce arbors of rotary wheels that avoid magnetisation of the pivot.

However, non-magnetic materials are often less hard than the magnetic materials usually used for rotary wheels. With such a recess, a protruding rim is present at the border of the hole, so that a pivot made from a soft non-magnetic material can be damaged by said rim, when the pivot comes out of the hole and goes back into it again, for example under the effect of an impact. After several impacts of this type, the pivot rapidly undergoes premature wear, which has repercussions on the precision of the movement afterward.

### SUMMARY OF THE INVENTION

The goal of the present invention is to overcome all or a part of the disadvantages cited above, by proposing an assembly, in particular for a timepiece, comprising a rotary wheel and a bearing, like a jewel, the rotary wheel being provided with at least one pivot including at least partly a non-magnetic material, preferably entirely, the bearing including a face provided with a hole formed in the body of the bearing and with a functional geometry at the entrance of the hole.

For this purpose, the assembly is remarkable in that the functional geometry has the shape of a cone, and in that the non-magnetic material of the pivot comprises an alloy to be chosen from materials containing copper, materials containing palladium or materials containing aluminium.

Via this assembly, soft non-magnetic materials can be used for pivots of rotary wheels, since the conical entrance of the hole avoids the risk of premature wear of the pivot in the case of impacts. Indeed, the rim bordering the hole and the cone protrudes much less, so that the pivot is not damaged if it comes out of the hole and goes back into it again after an impact. Moreover, the materials such as the alloys containing copper, containing palladium, or containing aluminium are particularly well adapted for this use.

According to a specific embodiment of the invention, the non-magnetic material has a Vickers hardness of less than 500 HV, preferably less than 450 HV, or even less than 400 HV.

According to a specific embodiment of the invention, the non-magnetic material is an alloy containing copper of the CuBe2 type.

According to a specific embodiment of the invention, the non-magnetic material is an alloy containing palladium comprising by weight:

between 25% and 55% of palladium,

between 25% and 55% of silver,

between 10% and 30% of copper,

between 0.5% and 5% of zinc,

gold and platinum with a total percentage of these two elements between 5% and 25%,

between 0% and 1% of one or more elements chosen from boron and nickel,

between 0% and 3% of one or more elements chosen from rhenium and ruthenium,

at most 0.1% of one or more elements chosen from iridium, osmium and rhodium, and

at most 0.2% of other impurities, the respective quantities of the components being such that added together, they reach 100%.

According to a specific embodiment of the invention, the non-magnetic material is an alloy comprising by weight: between 30% and 40% of palladium, between 25% and 35% of silver, between 10% and 18% of copper, between 0.5% and 1.5% of zinc, and the alloy comprises by weight gold and platinum with a total percentage of these two elements between 16% and 24%.

According to a specific embodiment of the invention, the non-magnetic material is an alloy comprising by weight:

between 34% and 36% of palladium,

between 29% and 31% of silver,

between 13.5% and 14.5% of copper,

between 0.8% and 1.2% of zinc,

between 9.5% and 10.5% of gold,

between 9.5% and 10.5% of platinum,

at most 0.1% of one or more elements chosen from iridium, osmium, rhodium and ruthenium, and

at most 0.2% of other impurities, the respective quantities of the components being such that added together, they reach 100%.

According to a specific embodiment of the invention, the non-magnetic material is an alloy containing palladium comprising by weight:

bween 25% and 55% of palladium,

between 25% and 55% of silver,

between 10% and 30% of copper,

between 0% and 5% of zinc,

between 0% and 2% of one or more elements chosen from rhenium, ruthenium, gold and platinum,

between 0% et 1% of one or more elements chosen from boron and nickel.

According to a specific embodiment of the invention, the non-magnetic material is an alloy comprising by weight between 38% and 43% of palladium, between 35% and 40% of silver, between 18% and 23% of copper, and between 0.5% and 1.5% of zinc.

According to a specific embodiment of the invention, the non-magnetic material is an alloy containing aluminium comprising by weight:

between 83% and 94.5% of aluminium,

between 4% and 7% of zinc,

between 1% and 4% of magnesium,

between 0.5% and 3% of copper,

between 0% and 3% of one or more elements chosen from chromium, silicon, manganese, titanium and iron.

According to a specific embodiment of the invention, the non-magnetic material is an alloy comprising by weight:

between 87.32% and 91.42% of aluminium,

between 5.1% and 6.1% of zinc,

between 2.1% and 2.9% of magnesium,

between 1.2% and 2% of copper,

between 0.18% and 0.28% of chromium,

between 0% and 0.4% of silicon,

between 0% and 0.3% of manganese,

between 0% and 0.2% of titanium, and

between 0% and 0.5% of iron.

According to a specific embodiment of the invention, the jewel comprises Al₂O₃ alumina or ZrO₂ zirconia.

According to a specific embodiment of the invention, the jewel comprises an upper face and a lower face, the lower face including the cone.

According to a specific embodiment of the invention, the hole is a through-hole in such a way as to connect said cone to the upper face of said jewel.

The invention also relates to a timepiece comprising such an assembly.

### BRIEF DESCRIPTION OF THE DRAWINGS

Other particularities and advantages will be clear from the following description thereof given below, for informational and in no way limiting purposes, in reference to the appended drawings, in which:

FIG. 1 is a diagram of an assembly comprising a jewel and a pivot of a rotary wheel known from the prior art;

FIG. 2 is a diagram of an assembly comprising a jewel and a pivot of a rotary wheel according to a first embodiment of the invention;

FIG. 3 is a diagram of a jewel according to a second embodiment of the invention.

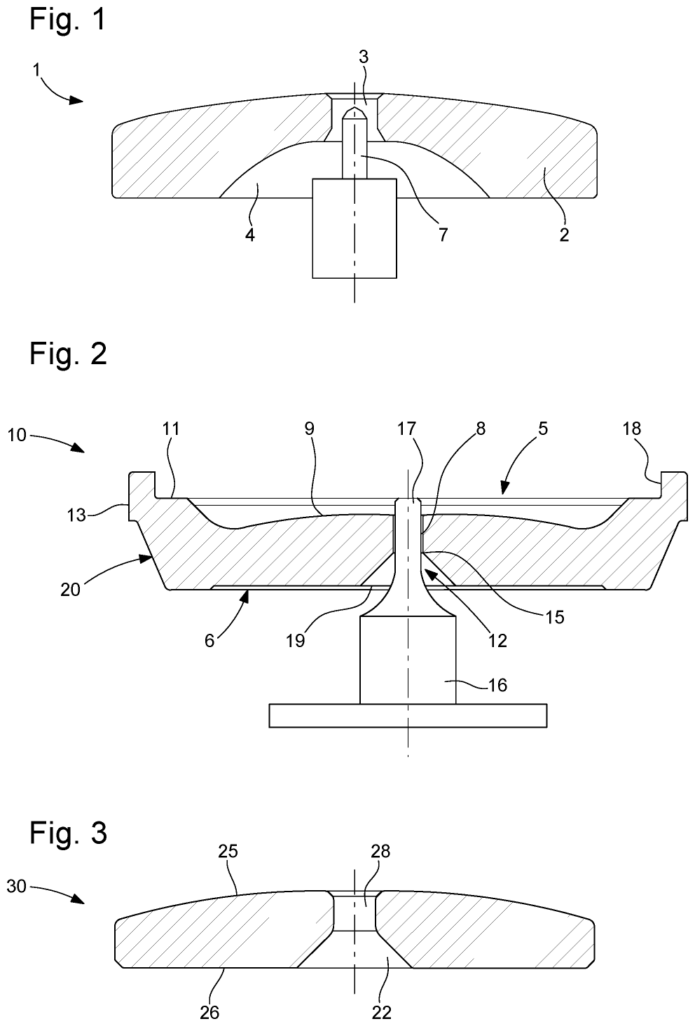

### DETAILED DESCRIPTION OF THE PREFERRED EMBODIMENTS

As explained above, the invention relates to an assembly comprising a rotary wheel and a bearing, such as a jewel, in particular for a timepiece. The jewel is intended to come in contact with a pivot of the rotary wheel, in order to make the latter mobile in rotation with minimum friction. However, such an assembly is not limited to the horological field and can be applied to any part mounted mobile in rotation with respect to a bearing.

The jewel is preferably formed from alumina or zirconia, with a crystallographic structure of the monocrystalline or polycrystalline type. The jewel forms for example a guide element intended to be mounted in a shock-absorber bearing of a timepiece.

In FIG. 2, a hole 8 intended to receive a pivot 17, also called trunnion, passes through the jewel 20 of the assembly 10. The jewel 20 includes an upper face 5 and a lower face 6, one of which comprises a cone 12 communicating with the through-hole 8. In other words, the hole 8 communicates with the upper face 5 and also with a substantially conical recess defined in the lower face 6. This recess thus forms a cone for insertion of the pierced jewel 20. The cone 12 preferably has a rotational symmetry.

The cone 12 has a first opening 19 at its base and a second opening at its apex. The first opening 19 is larger than the second, and is formed in the lower face 6 of the jewel 20. The linking of the cone 12 and of the hole 8 is carried out by the second opening to form a rim 15.

Thus, the flaring of the cone 12 allows to easily insert the pivot 17 of the arbor 16 of a part mobile in rotation, in particular in the case of an impact. The angle of the cone is chosen to avoid the rim 15 formed by the top of the cone and the hole 8 being too protruding. For example an angle between 30° and 120°, preferably between 45° and 90°, is chosen.

It is also noted that an inner wall of the body of this jewel 20 defined at the hole 8 includes a rounded zone intended to minimise the contact with the pivot but also to facilitate possible lubrication.

The upper face 5 of the jewel comprises an edge 18, in particular to laterally surround an endstone in the case of a bearing. The edge 18 is preferably peripheral, that is to say that it defines the border of the upper face 5 of the jewel 20. Moreover, it defines an inner zone 9 of the upper face 5 including a bearing face 11 and the exit of the through-hole 8, and a zone 9 concentrically convex from the bearing face 11 to the hole 8.

An upper face 5 with such an edge 18 allows, for example, to laterally block an element arranged on the upper face of the jewel 20. In the case of a bearing for a balance axis, in which the jewel 20 acts as a guide element, an endstone jewel can be disposed in such a way that it is laterally blocked by the inner side of the edge 18 while resting on the bearing face 11. The endstone jewel is dimensioned to correspond to the zone 9 of the jewel 10. The jewel thus forms an axial and radial support of an endstone. The endstone, not shown in the drawings, can be nested in the jewel 10 to support it axially and maintain it laterally.

Moreover, the jewel 10 has a partly flared peripheral face 13 connecting the lower face 6 having a smaller surface area to the upper face 5 having a larger surface area.

FIG. 3 shows an alternative embodiment of a jewel 30 of an assembly. The jewel 30 has a different shape, the upper face 25 being domed and the lower face 26 being substantially flat. This jewel 30 does not comprise an edge, and must be inserted into a specific ring (or setting). The through-hole 28 and the cone 22 are similar to those of FIG. 2.

According to the invention, the rotary wheel is provided with a pivot including at least partly a non-magnetic material, preferably entirely. The non-magnetic material allows to limit the sensitivity of the pivot to magnetic fields.

The non-magnetic material of the pivot comprises a metal alloy to be chosen from materials containing copper, containing palladium, or materials containing aluminium. The non-magnetic material comprised in the pivot is soft, that is to say that it has a Vickers hardness of less than 500 HV, preferably less than 450 HV, or even less than 400 HV or 350 HV. Thus, the non-magnetic material is a “soft” material with respect to the harder metal materials used to form usual pivots of rotary wheels.

In a first embodiment, the non-magnetic material comprises an alloy of copper and of beryllium, of the CuBe₂ type. Preferably, the pivot is formed substantially entirely from this alloy of copper and of beryllium. The alloy generally comprises at least 90% of copper, or even at least 95% of copper, and even up to 98% of copper, which is completed by beryllium.

In a second embodiment, the non-magnetic material is an alloy comprising by weight:

between 25% and 55% of palladium,

between 25% and 55% of silver,

between 10% and 30% of copper,

between 0.5% and 5% of zinc,

gold and platinum with a total percentage of these two elements between 15% and 25%,

between 0% and 1% of one or more elements chosen from boron and nickel,

between 0% and 3% of one or more elements chosen from rhenium and ruthenium,

at most 0.1% of one or more elements chosen from iridium, osmium, and rhodium, and

at most 0.2% of other impurities, the respective quantities of the components being such that added together, they do not exceed 100%.

Advantageously, the non-magnetic is an alloy comprising by weight:

between 30% and 40% of palladium,

between 25% and 35% of silver,

between 10% and 18% of copper,

between 0.5% and 1.5% of zinc,

between 8 and 12% of gold and 8 and 12% of platinum with a proportion of rhenium and ruthenium between 0 and 6% by weight.

According to a preferred alternative, the non-magnetic material is an alloy comprising by weight:

between 34% and 36% of palladium,

between 29% and 31% of silver,

between 13.5% and 14.5% of copper,

between 0.8% and 1.2% of zinc,

between 9.5% and 10.5% of gold,

between 9.5% and 10.5% of platinum,

at most 0.1% of one or more elements chosen from iridium, osmium, rhodium and ruthenium, and

at most 0.2% of other impurities, the respective quantities of the components being such that added together, they reach 100%.

According to an even more preferred alternative, the non-magnetic material is an alloy consisting by weight of 35% of palladium, 30% of silver, 14% of copper, 10% of gold, 10% of platinum and 1% of zinc.

In the third embodiment, the non-magnetic material is an alloy comprising by weight:

between 25% and 55% of palladium,

between 25% and 55% of silver,

between 10% and 30% of copper,

between 0% and 5% of zinc,

between 0% and 25% of one or more elements chosen from rhenium, ruthenium, gold and platinum,

between 0% and 10% of one or more elements chosen from boron and nickel.

Preferably, the non-magnetic material is an alloy comprising by weight:

between 38% and 43% of palladium; and/or

between 35% and 40% of silver; and/or

between 18% and 23% of copper; and/or

between 0.5% and 1.5% of zinc.

Even more particularly, the non-magnetic material is an alloy comprising 41% of palladium, 37.5% of silver, 20% of copper, 1% of zinc and 0.5% of platinum.

In a fourth embodiment of the invention containing aluminium, the non-magnetic material is an alloy comprising by weight:

between 83% and 94.5% of aluminium,

between 4% and 7% of zinc,

between 1% and 4% of magnesium,

between 0.5% and 3% of copper,

between 0% and 3% of one or more elements chosen from chromium, silicon, manganese, titanium and iron.

Preferably, an alloy known by the name of aluminium alloy of the 7075 type (zicral) is used, which comprises more precisely by weight:

between 87.32% and 91.42% of aluminium,

between 5.1% and 6.1% of zinc,

between 2.1% and 2.9% of magnesium,

between 1.2% and 2% of copper,

between 0.18% and 0.28% of chromium,

between 0% and 0.4% of silicon,

between 0% and 0.3% of manganese,

between 0% and 0.2% of titanium, and

between 0% and 0.5% of iron.

Of course, the present invention is not limited to the examples illustrated but is capable of various alternatives and modifications that will appear to a person skilled in the art. For example, other materials such as brass, German silver, declafor, or even soft non-magnetic steels are known.

1. An assembly (10) for a timepiece, comprising a rotary wheel and a bearing, including a jewel (20, 30), the rotary wheel being provided with at least one pivot (17) including at least partly a non-magnetic material, the bearing including a face (6, 26) provided with a hole (8, 28) formed in the body of the bearing and with a functional geometry at the entrance of the hole (8, 28), wherein the functional geometry has the shape of a cone (12, 22), and wherein the non-magnetic material of the pivot (17) comprises an alloy to be chosen from materials containing copper, materials containing palladium, or materials containing aluminium.

2. The assembly, according to claim 1, wherein the non-magnetic material has a Vickers hardness of less than 500 HV, preferably less than 450 HV, or even less than 400 HV.

3. The assembly, according to claim 1, wherein the non-magnetic material is an alloy containing copper of the CuBe2 type.

4. The assembly, according to claim 1, wherein the non-magnetic material is an alloy containing palladium comprising by weight:
between 25% and 55% of palladium,
between 25% and 55% of silver,
between 10% and 30% of copper,
between 0.5% and 5% of zinc,
gold and platinum with a total percentage of these two elements between 5% and 25%,
between 0% and 1% of one or more elements chosen from boron and nickel,
between 0% and 3% of one or more elements chosen from rhenium and ruthenium,
at most 0.1% of one or more elements chosen from iridium, osmium and rhodium, and
at most 0.2% of other impurities, the respective quantities of the components being such that added together, they reach 100%.

5. The assembly, according to claim 4, wherein the non-magnetic material is an alloy comprising by weight: between 30% and 40% of palladium, between 25% and 35% of silver, between 10% and 18% of copper, between 0.5% and 1.5% of zinc, and the alloy comprises by weight gold and platinum with a total percentage of these two elements between 16% and 24%.

6. The assembly, according to claim 5, wherein the non-magnetic material is an alloy comprising by weight:
between 34% and 36% of palladium,
between 29% and 31% of silver,
between 13.5% and 14.5% of copper,
between 0.8% and 1.2% of zinc,
between 9.5% and 10.5% of gold,
between 9.5% and 10.5% of platinum,
at most 0.1% of one or more elements chosen from iridium, osmium, rhodium and ruthenium, and
at most 0.2% of other impurities, the respective quantities of the components being such that added together, they reach 100%.

7. The assembly, according to claim 1, wherein the non-magnetic material is an alloy containing palladium comprising by weight:
between 25% and 55% of palladium,
between 25% and 55% of silver,
between 10% and 30% of copper,
between 0% and 5% of zinc,
between 0% and 2% of one or more elements chosen from rhenium, ruthenium, gold and platinum,
between 0% et 1% of one or more elements chosen from boron and nickel.

8. The assembly, according to claim 7, wherein the non-magnetic material is an alloy comprising by weight between 38% and 43% of palladium, between 35% and 40% of silver, between 18% and 23% of copper, and between 0.5% and 1.5% of zinc.

9. The assembly, according to claim 1, wherein the non-magnetic material is an alloy containing aluminium comprising by weight:
between 83% and 94.5% of aluminium,
between 4% and 7% of zinc,
between 1% and 4% of magnesium,
between 0.5% and 3% of copper,
between 0% and 3% of one or more elements chosen from chromium, silicon, manganese, titanium and iron.

10. The assembly, according to claim 9, wherein the non-magnetic material is an alloy comprising by weight:
between 87.32% and 91.42% of aluminium,
between 5.1% and 6.1% of zinc,
between 2.1% and 2.9% of magnesium,
between 1.2% and 2% of copper,
between 0.18% and 0.28% of chromium,
between 0% and 0.4% of silicon,
between 0% and 0.3% of manganese,
between 0% and 0.2% of titanium, and
between 0% and 0.5% of iron.

11. The assembly, according to claim 1, wherein the jewel (20, 30) comprises Al2O3 alumina or ZrO2 zirconia.

12. The assembly, according to claim 1, wherein the jewel (20, 30) comprises an upper face (5, 25) and a lower face (6, 26), the lower face (6, 26) including the cone (12, 22).

13. The assembly, according to claim 1, wherein the hole (8, 28) is a through-hole, in such a way as to connect said cone (12, 22) to the upper face (5, 25) of said jewel (20, 30).

14. A timepiece comprising an assembly (10) according to claim 1.
